(19) United States
(12) Patent Application Publication
(10) Pub. No.: US 2008/0148750 A1
(43) Pub. Date: Jun. 26, 2008

(54) WATER AMOUNT CONTROL DEVICE FOR ICE MACHINE

(76) Inventor: Shih-Hsien HSU, Taipei Hsien (TW)

Correspondence Address: Joe McKinney Muncy, PO Box 1364, Fairfax, VA, 22038-1364, US

(21) Appl. No.: 11/959,255

(22) Filed: Dec. 18, 2007

(30) Foreign Application Priority Data
Dec. 20, 2006 (TW) 095147758

(51) Int. Cl. G01F 23/00; F25C 1/00

(52) U.S. Cl. 62/188

(57) ABSTRACT

A water amount control device for an ice machine, which at least includes a main control unit and a water supplying unit, is provided. The present invention utilizes a detecting unit which is connected to the main control unit in the ice machine to detect the water amount in an ice tray of the ice machine, so as to decide if the water amount in the ice tray reaches a preset level. If the water amount does not reach the preset level, the main control unit commands the water supplying unit to maintain water supplying until the preset amount is reached, and since the preset level is reached, the detecting unit may send out a signal to the main control unit so as to command the water supplying unit to stop water supplying.

### FIELD OF THE INVENTION

The present invention is related to a water amount control device for an ice machine, and more particularly to a control device in which a detecting unit is used for detecting the water level in an ice tray so as to decide if the ice making process starts.

### BACKGROUND OF THE INVENTION

People always add ice into various kinds of drinks or use ice for cooling, so that the ice machine manufacturers are devoted to develop different kinds of ice machines, for improving the ice making speed and for automating the process. Conventionally, a time counting method is utilized in the ice machine so that the ice making procedures can be sequentially completed in a fixed duration, for example, R.O.C. application serial No. 86119985, entitled “Automatic ice machine for refrigerator”, which controls the water outflow amount through controlling the opening time of an electromagnetic valve. As shown in FIG. 1 of this application, the system decides if the water amount is sufficient by calculating the water supplying time. However, in practice, it might have the problem of insufficient or exceeded water supplying because the water supplying time is preset by the manufacturer or is set according to the water supplying speed in the test run. Therefore, as the machine is delivered to the client at different places or at different floors, which means the pressure and speed of water will be different, the water supplying amount might easily become insufficient or exceeded. If the water amount is not sufficient, the ice making speed may become slower or the ice machine might have a bad working efficiency, and if the water amount is exceeded to cause overflowing, the components of the ice machine might be damaged or even be frozen. Therefore, there still has the need to improve the conventional design. R.O.C. application serial No. 85102068 discloses that a water pump is controlled to supply water in a given time period, in which other components act sequentially, too. However, the problem described above still can not be solved, that is, the pressure and speed difference of water at each client might cause insufficient or exceeded water amount if the procedures are executed sequentially, which actually will reduce the efficiency or damage the ice machine.

### SUMMARY OF THE INVENTION

Consequentially, the object of the present invention is to provide a control device which can decide if the ice making process starts according to the real water amount in the ice tray.

The ice machine of the present invention includes a main control unit, a cooling unit, a temperature sensing unit and a water supplying unit, and also includes a detecting unit connected to the main control unit. The main control unit can send out signals to control acts of each unit in the ice machine. The detecting unit can detect if the water amount in an ice tray of the ice machine reaches a preset water level. If the water amount is insufficient a signal representing insufficient water amount is sent to the main control, so that the main control unit can control the water supplying unit to keep supplying water to the ice tray. If the water amount reaches the preset water level, the detecting unit sends out a signal representing sufficient water amount to the main control unit for commanding the water supplying unit to stop water supply.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram showing a conventional ice machine;

FIG. 2 is a block diagram showing an ice machine according to the present invention;

FIG. 3 is a three-dimensional drawing showing an embodiment of the present invention;

FIG. 4 a three-dimensional drawing showing an embodiment of the present invention at another angle;

FIG. 5 is a schematic view showing the water supplying according to the present invention; and

FIG. 6 is a schematic view showing the situation as the water supplying stops according to the present invention

### DESCRIPTION OF THE PREFERRED EMBODIMENT

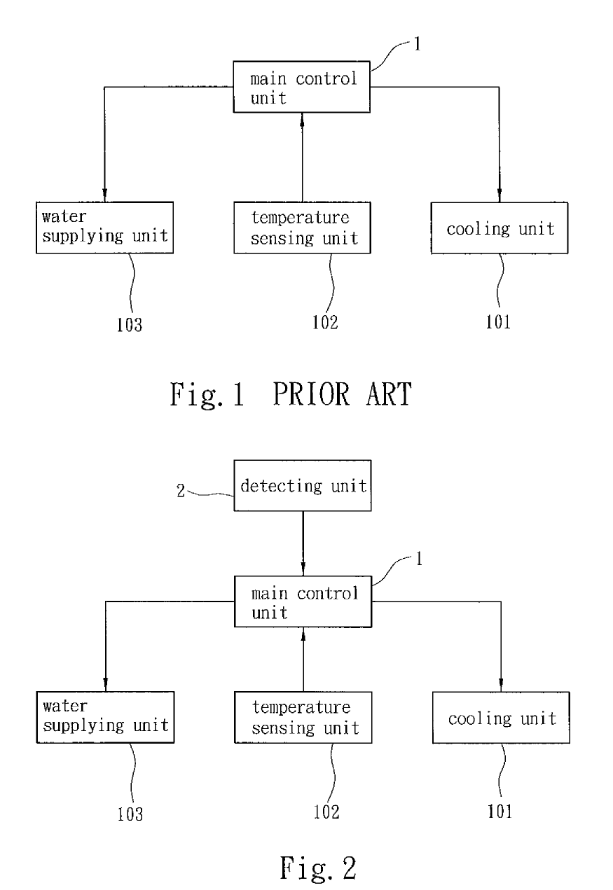

Please refer to FIG. 1, which shows the architecture of the conventional ice machine. The ice machine includes a main control unit 1, a cooling unit 101, a temperature sensing unit 102 and a water supplying unit 103. In the complete ice making process, first, the main control unit 1 commands the water supplying unit 103 to supply water, the water supplying unit 103 estimates the supplied water amount through time counting, the temperature sensing unit 102 detects the temperature and then transmits a temperature signal back to the main control unit 1, and the main control unit 1 adjusts the action of the cooling unit 101. In this control method for the conventional water supplying unit 103, water supplying is depended on the preset supplying time, and the real water amount is not monitored, so that there is the need to improve thereof.

Please refer to FIG. 2 showing the architecture of an ice machine according to the present invention. Except the main control unit 1, the cooling unit 101, the temperature sensing unit 102 and the water supplying unit 103, as shown above, the ice machine of the present invention also includes a detecting unit 2 for detecting that if the water level reaches a preset ice-making water level. If the preset ice-making water level is reached, the detecting unit 2 transmits a signal back to the main control unit 1 for notifying that the preset water level is reached, so that the main control unit 1 commands the water supplying unit 103 to stop water supplying. Moreover, the detecting unit 2 has at least a detector 20 for detecting the water level in the ice tray, wherein the detector 20 is an impedance detecting device, and through a change of the impedance when the water level reaches a detecting board, the detecting unit 2 sends out a first signal to the main control unit 1 for commanding the water supplying unit 103 to stop water supplying.

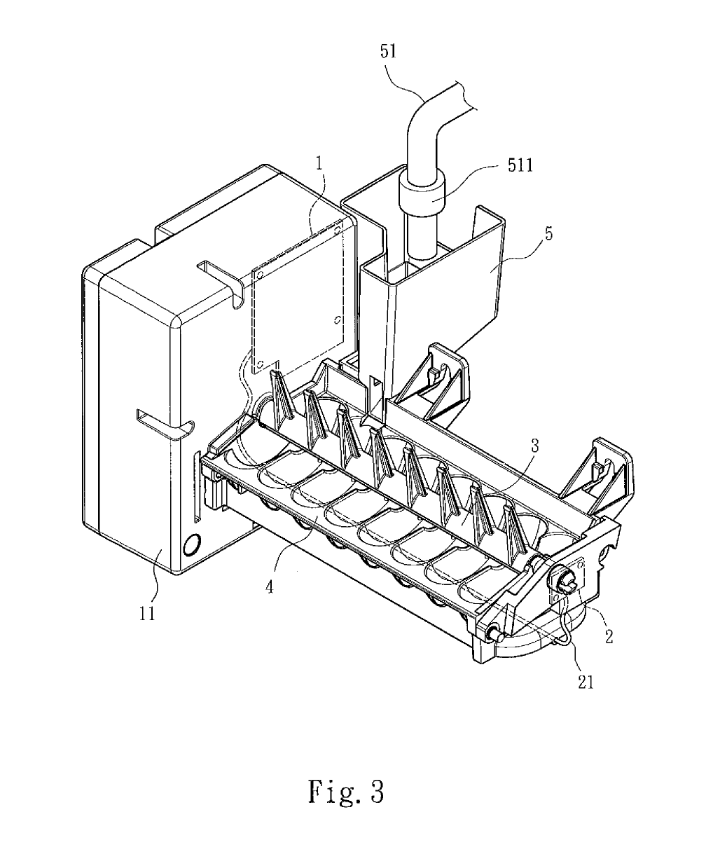

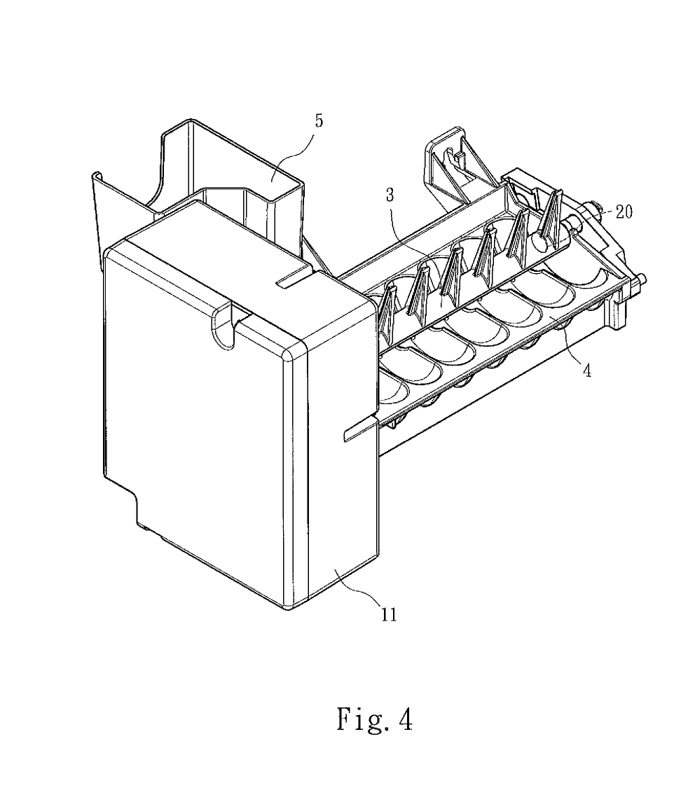

Please refer to FIG. 3 and FIG. 4 showing the preferred embodiment of the present invention. In the embodiment, the ice machine includes a housing 11 for accommodating the main control unit 1, an ice tray 4 and an ice sweeping shaft 3, and the water supplying unit 103 includes a water inflow trough 5 located above the ice tray 4, a water pipe 51 and an electromagnetic valve 511 controlled by the main control unit 1. Under the water inflow trough 5, an opening is mounted thereon so that the water can flow into the ice tray 4 through the opening. The water inflow trough 5 is supplied by the water pipe 51, and the electromagnetic valve 511 whose opening and closing is controlled by the main control unit 1 is mounted on the water pipe 51. Furthermore, the detecting unit 2 is located at the end of the ice tray 4 far from the water supplying unit 103. The detecting unit 2 includes at least a detector 20 for detecting the water level in the ice tray 4, so that when the water level reaches a preset height, the detecting unit 2 sends out a first signal to the main control unit 1 for commanding the electromagnetic valve 511 to continue water supplying or to close, wherein the signal is transmitted by a conducting wire 21.

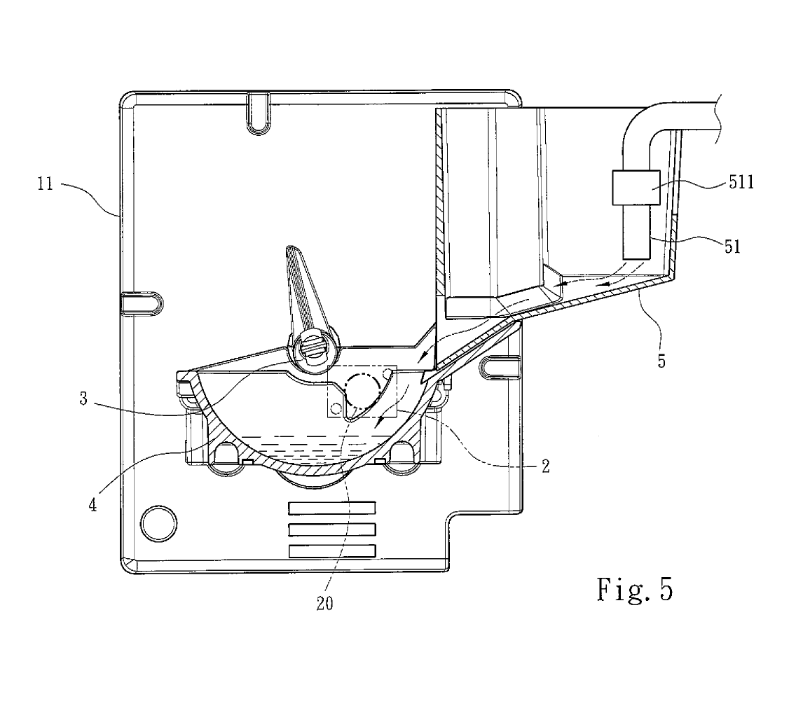

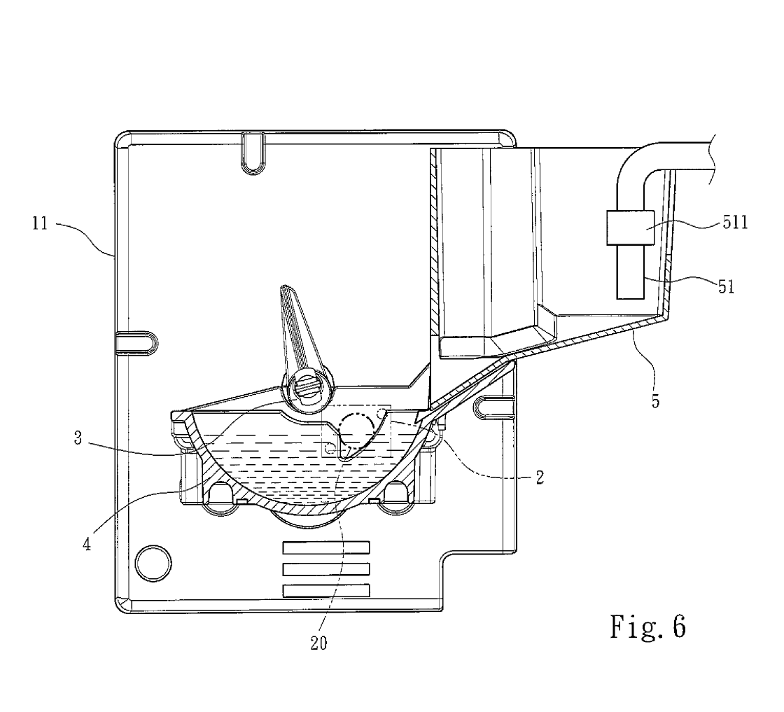

Please refer to FIG. 5 and FIG. 6 which are schematic views respectively showing the water supplying and also the situation as water supplying stops. In FIG. 5, the electromagnetic valve 511 is opened, so that the water flows through the water pipe 51 and the water inflow trough 5 and then flows into the ice tray 4. Since the water level does not reach a preset height, the detector 20 of the detecting unit 2 continuously sends out signals to the main control unit 1 for maintaining the opening of the electromagnetic valve 511. Then, when the water level reaches the preset height, the detector 20 of the detecting unit 2 produces a first signal and transmits thereof to the main control unit 1, so that the main control unit 1 commands the electromagnetic valve 511 to close immediately, so as to maintain a proper water level, thereby providing a great ice-making efficiency and also preventing the components from being damaged.

Although the present invention has disclosed through the preferred embodiment described above, it is not restricted. Here, the main control unit 1 can be an integrated circuit or can be a programmable controller, the detector 20 can be an infrared ray detecting device, so that through emitting and receiving the infrared rays, the water level can be detected for transmitting a first signal to the main control unit 1.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fill extent indicated by the broad general meaning of the terms in which the appended claims are expressed.

What is claimed is:

1. A water amount control device for an ice machine, used to control a water amount in an ice tray of the ice machine, the water amount control device comprising:
a water supplying unit, for supplying water to the ice tray;
a detecting unit, mounted at the end of the ice tray far from the water supplying unit, for detecting the water amount in the ice tray and sending out a first signal when the water amount reaches a preset water level; and
a main control unit, connected to the water supplying unit and the detecting unit, wherein when receiving the first signal, the main control unit controls the water supplying unit to stop water supplying.

2. The water amount control device for ice machine as claimed in claim 1, wherein the detecting unit includes a detector for detecting water level.

3. The water amount control device for ice machine as claimed in claim 2, wherein the detector is exposed out of the ice tray so as to produce an impedance change through contacting with the water surface.

4. The water amount control device for ice machine as claimed in claim 2, wherein the detector is an impedance detecting device.

5. The water amount control device for ice machine as claimed in claim 2, wherein the detector is an infrared detecting device.

6. The water amount control device for ice machine as claimed in claim 1, wherein the water supplying unit comprises an electromagnetic valve.

7. The water amount control device for ice machine as claimed in claim 6, wherein the main control unit sends out an electrical signal to open or close the electromagnetic valve.

8. The water amount control device for ice machine as claimed in claim 1, wherein the main control unit is an integrated circuit.

9. The water amount control device for ice machine as claimed in claim 1, wherein the main control unit is a programmable controller.
